(19) United States
(12) Patent Application Publication
(10) Pub. No.: US 2025/0122902 A1
(43) Pub. Date: Apr. 17, 2025

(54) RADIAL FOIL BEARING WITH BUMP FOIL

(71) Applicant: IHI Corporation, Tokyo (JP)

(72) Inventors: Shonosuke ISHIKAWA, Tokyo (JP); Yusei YOKOYAMA, Tokyo (JP); Wataru UEDA, Tokyo (JP)

(21) Appl. No.: 19/002,696

(22) Filed: Dec. 27, 2024

Related U.S. Application Data
(63) Continuation of application No. PCT/JP2023/027437, filed on Jul. 26, 2023.

(30) Foreign Application Priority Data
Jul. 26, 2022 (JP) 2022-118530

(51) Int. Cl. F16C 17/02; F16C 33/14

(52) U.S. Cl. CPC F16C 17/024; F16C 33/14; F16C 2360/24

(57) ABSTRACT

A radial foil bearing includes a top foil, a bump foil located on an outside opposite to the facing surface of the top foil, and a bearing housing surrounding the bump foil. The bump foil includes a cylindrical portion surrounding the top foil in a cylindrical shape, and an elastic piece supported by the bearing housing and configured to deform independently of the cylindrical portion.

### CROSS-REFERENCE TO RELATED APPLICATIONS

This application is a continuation application of PCT Application No. PCT/JP2023/027437, filed on Jul. 26, 2023, which claims the benefit of priority from Japanese Patent Application No. 2022-118530, filed on Jul. 26, 2022. The entire contents of the above listed PCT and priority applications are incorporated herein by reference.

### BACKGROUND

### Field

The present disclosure relates to a radial foil bearing and a method for manufacturing the radial foil bearing.

### Description of the Related Art

Japanese Unexamined Patent Application Publication No. 2004-190761 discloses a radial foil bearing which includes a thin plate-shaped top foil surrounding a rotating shaft, a thin plate-shaped bump foil surrounding the top foil, and a cylindrical housing accommodating the top foil and the bump foil. WO 2014/098005 A1, Japanese Unexamined Patent Publication No. 2017-82909, Japanese Unexamined Patent Publication No. 2018-150971, and Japanese Unexamined Patent Publication No. 2019-82195 each disclose a radial foil bearing. The radial foil bearing include a top foil that is elastically supported directly by the housing without including a bump foil.

### SUMMARY

Disclosed herein is an example radial foil bearing. The radial foil bearing may include a top foil including a facing surface facing a rotating shaft, a bump foil located on an outside opposite to the facing surface of the top foil, and a bearing housing disposed to surround the bump foil. The bump foil may include a cylindrical portion surrounding the top foil in a cylindrical shape, and an elastic piece adjacent to the cylindrical portion in an axial direction of the rotating shaft, the elastic piece being deformable independently of the cylindrical portion and expandable in a circumferential direction. The elastic piece may be supported by the bearing housing.

The bump foil may include a cylindrical portion and an elastic piece, and the elastic piece may be deformable independently of the cylindrical portion. The elastic piece may be directly or indirectly supported by the bearing housing and may support the top foil via the cylindrical portion adjacent in the axial direction. In addition, since the elastic piece may be expandable in the circumferential direction while being supported by the bearing housing, the elastic piece may be resistant to vibration of the rotating shaft rotating at a high speed, and the like, and a stable support may be achieved.

In some examples, the elastic piece and the cylindrical portion may be integrally formed, and the bump foil may include a slit structure separating the elastic piece from the cylindrical portion so that the elastic piece is deformable independently of the cylindrical portion. Since the elastic piece and the cylindrical portion are integrally provided, when installation of the cylindrical portion is completed, installation of the elastic piece is completed. As a result, assemblability at the time of installing the bump foil can be improved.

In some examples, the bump foil may include a coupling portion coupling the cylindrical portion and the elastic piece, the elastic piece may include a peak edge portion formed on a side opposite to the coupling portion in the circumferential direction, and a side edge portion extending from the peak edge portion to the coupling portion. The peak edge portion may be formed by the slit structure to be a free end. The peak edge portion to be a free end is movable with the coupling portion coupled to the cylindrical portion as a fulcrum.

In some examples, the bump foil may include a first end edge being an end on one side in the axial direction, and a second end edge opposite to the first end edge in the axial direction, the slit structure may include a slit forming the peak edge portion, and a side slit connected to the slit and forming the side edge portion, and the slit and the side slit may be spaced apart from the first end edge and the second end edge and are configured to close within the bump foil. It may form the elastic piece having a desired elastic force at a position spaced apart from the first end edge or the second end edge of the bump foil, for example, at a position close to the center in the axial direction.

In some examples, the bump foil may include a first end edge being an end on one side in the axial direction, and a second end edge opposite to the first end edge in the axial direction. The slit structure may include a slit forming the peak edge portion. The slit may be opened at the first end edge or the second end edge, and at least a portion of the side edge portion may be formed at the first end edge or the second end edge where the slit is opened. The slit forming the peak edge portion to be a free end is opened at the first end edge or the second end edge of the bump foil. Therefore, the peak edge portion can be easily formed by making a cut or the like from the first end edge or the second end edge.

In some examples, the slit structure may include a slit forming the peak edge portion. The elastic piece may include a plurality of crest portions arranged adjacent to each other in the circumferential direction and expandable in the circumferential direction by elastic expansion. The slit may extend along the crest portions while avoiding the crest portions between the crest portions arranged adjacent to each other. An elastic function of the plurality of crest portions expandable in the circumferential direction is hardly impaired by the elastic expansion.

In some examples, the slit structure may include a slit forming the peak edge portion, a plurality of the elastic pieces may be provided side by side in the circumferential direction, and the peak edge portion of one of the elastic pieces adjacent to each other and the peak edge portion of another of the elastic pieces may be formed by the slit in common. By making the slit forming the peak edge portion of one of the adjacent elastic pieces and the peak edge portion of another of the other elastic pieces in common, the interval between the adjacent elastic pieces can be reduced, and shapes and dimensions of the elastic pieces, the number of elastic pieces formed in the circumferential direction, and the like can be easily optimized.

In some examples, the slit structure may further include a side slit forming the side edge portion, and a width of the slit in the circumferential direction may be larger than a width of the side slit in the axial direction. For example, when the peak edge portion of one of the elastic pieces adjacent to each other in the circumferential direction and the peak edge portion of another of the elastic pieces are formed by a slit in common, when the elastic pieces are expanded, the peak edge portion of the one of the elastic pieces and the peak edge portion of the another of the elastic pieces move in a direction of approaching each other. Here, since the width of the slit is larger than the width of the side slit, it may prevent interference between the peak edge portions as compared with a case where the width of the slit and the width of the side slit are the same.

In some examples, a set foil disposed to surround the bump foil and supporting the elastic piece may be included to prevent the elastic piece from springing outward from the cylindrical portion and prevent the elastic function from deteriorating. In addition, by providing the set foil, friction is generated between the bump foil and the set foil, and damping performance is improved.

Additionally, an example method for manufacturing a radial foil bearing including a top foil including a facing surface facing a rotating shaft, a bump foil located on an outside of the top foil, and a bearing housing disposed to surround the bump foil. This manufacturing method may include rolling a stack in which the top foil in an unfolded state and the bump foil in an unfolded state are overlapped to form a cylindrical foil assembly, and inserting and installing the foil assembly into a cylindrical bearing housing so as to surround the rotating shaft. The bump foil includes a cylindrical portion surrounding the top foil in a cylindrical shape, and an elastic piece adjacent to the cylindrical portion in an axial direction of the rotating shaft, the elastic piece being expandable independently of the cylindrical portion and expandable in a circumferential direction. By inserting the foil assembly into the bearing housing, the elastic piece is supported by the bearing housing. According to this manufacturing method, a radial foil bearing capable of stably supporting a rotating shaft during high-speed rotation while improving assemblability may be achieved.

In some examples, in forming the foil assembly, a set foil in an unfolded state may be disposed so as to overlap the bump foil on a side opposite to the top foil to form the stack, and the stack may be rolled to form the foil assembly. Accordingly, the radial foil bearing prevents the elastic function from deteriorating and improves damping performance.

### BRIEF DESCRIPTION OF THE DRAWINGS

FIG. 1 is a cross-sectional view illustrating an example rotary machine.

FIG. 2 is a perspective view illustrating an example radial foil bearing.

FIG. 3 is a cross-sectional view of the radial foil bearing taken along a cross section orthogonal to the rotating shaft.

FIG. 4 is a perspective view of a foil assembly.

FIG. 5A is a plan view illustrating a bump foil in an unfolded state.

FIG. 5B is a perspective view illustrating a bump foil in an unfolded state.

FIG. 6 is a schematic cross-sectional view for functionally describing the radial foil bearing.

FIG. 7A is a perspective view illustrating an operation of manufacturing process of the radial foil bearing, showing a top foil, a bump foil, and a set foil are arranged vertically.

FIG. 7B is a perspective view illustrating an operation of manufacturing process of the radial foil bearing, showing a foil assembly (stack) before being rolled.

FIG. 7C is a perspective view illustrating an operation of manufacturing process of the radial foil bearing, showing the foil assembly is inserted into a bearing housing.

FIG. 8 is a schematic cross-sectional view for functionally describing a radial foil bearing according to a modification.

FIG. 9 is a plan view illustrating an example bump foil in an unfolded state as viewed from a back, and it includes a partially enlarged view.

FIG. 10 is a plan view illustrating an example bump foil, in an unfolded state as viewed from the back.

### DETAILED DESCRIPTION

In the following description, with reference to the drawings, the same reference numbers are assigned to the same components or to similar components having the same function, and overlapping description is omitted.

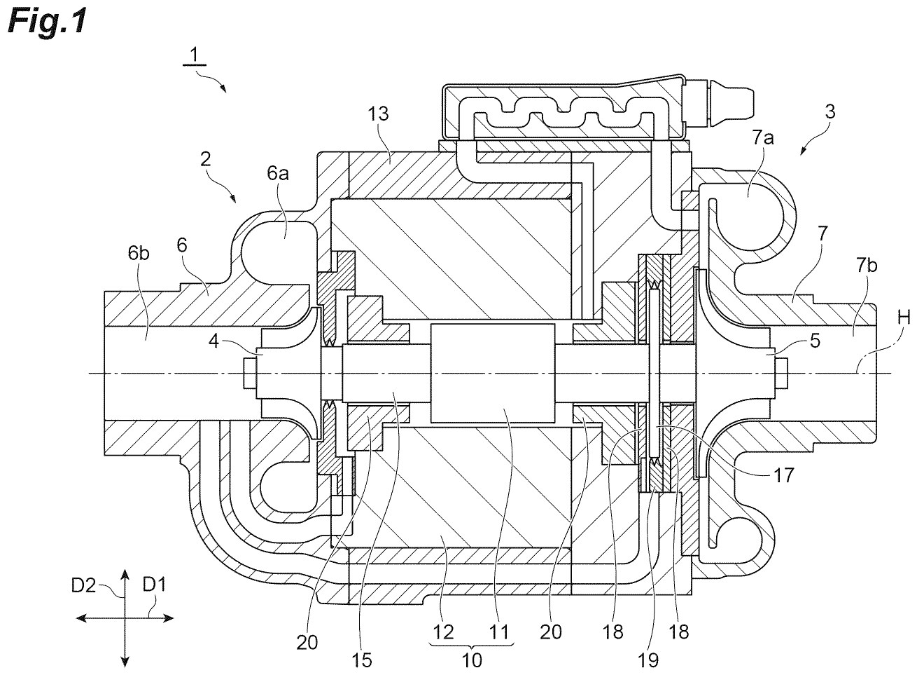

FIG. 1 illustrates an example rotary machine 1. The rotary machine 1 is, for example, an electrically-assisted turbocharger. The rotary machine 1 includes a turbine 2, a compressor 3, an electric motor 10, and a rotating shaft 15. The turbine 2 includes a turbine impeller 4 provided at one end of the rotating shaft 15 and a turbine housing 6 that accommodates the turbine impeller 4. The compressor 3 includes a compressor impeller 5 provided at the other end of the rotating shaft 15, and a compressor housing 7 accommodating the compressor impeller 5.

A rotor 11 of the electric motor 10 is disposed, for example, at the center of the rotating shaft 15. The rotor 11 is fixed to the rotating shaft 15 and is rotatable together with the rotating shaft 15. A stator 12 of the electric motor 10 is disposed to surround the rotor 11. The stator 12 is fixed to a motor housing 13 provided between the turbine housing 6 and the compressor housing 7. The stator 12 can rotate the rotor 11 by generating a magnetic field around the rotating shaft 15. The rotation of the rotating shaft 15 is assisted by the cooperation of the rotor 11 and the stator 12.

In the rotary machine 1, exhaust gas discharged from the internal combustion engine flows into the turbine housing 6 through a scroll flow path 6a, and rotates the turbine impeller 4 about the rotation axis H. The exhaust gas that has rotated the turbine impeller 4 is discharged through a discharge port 6b of the turbine housing 6. When the turbine impeller 4 rotates as described above, the compressor impeller 5 rotates via the rotating shaft 15. At this time, torque is applied to the rotating shaft 15 by the electric motor 10, so that the rotation of the rotating shaft 15 and the compressor impeller 5 is assisted. The rotating compressor impeller 5 sucks external air through a suction port 7b of the compressor housing 7. This air is compressed while passing through the compressor impeller 5 and a scroll flow path 7a. The compressed air is discharged from a discharge port of the compressor housing 7 and supplied to the internal combustion engine.

The rotating shaft 15 is rotatably supported around the rotation axis H via a plurality of bearings. At least one of the plurality of bearings is a radial foil bearing 20 of the present disclosure. In the example illustrated in FIG. 1, a pair of radial foil bearings 20 is provided at both ends of the rotating shaft 15, respectively. The radial foil bearing 20 is an air bearing that supports the rotating shaft 15 in the radial direction (for example, the direction perpendicular to the rotation axis H).

In the rotary machine 1 illustrated in FIG. 1, a thrust collar 17 and a pair of thrust air bearings 18 are provided between the radial foil bearing 20 closer to the compressor impeller 5 out of the pair of radial foil bearings 20 and the compressor impeller 5. The thrust collar 17 is a disk-shaped member formed so as to protrude in a flange shape around the rotating shaft 15. The pair of thrust air bearings 18 is provided at positions sandwiching the thrust collar 17. A spacer 19 surrounding the thrust collar 17 is provided between the pair of thrust air bearings 18. The thrust collar 17 and the pair of thrust air bearings 18 support the rotating shaft 15 in a thrust direction (for example, a direction parallel to the rotation axis H).

### <Radial Foil Bearing>

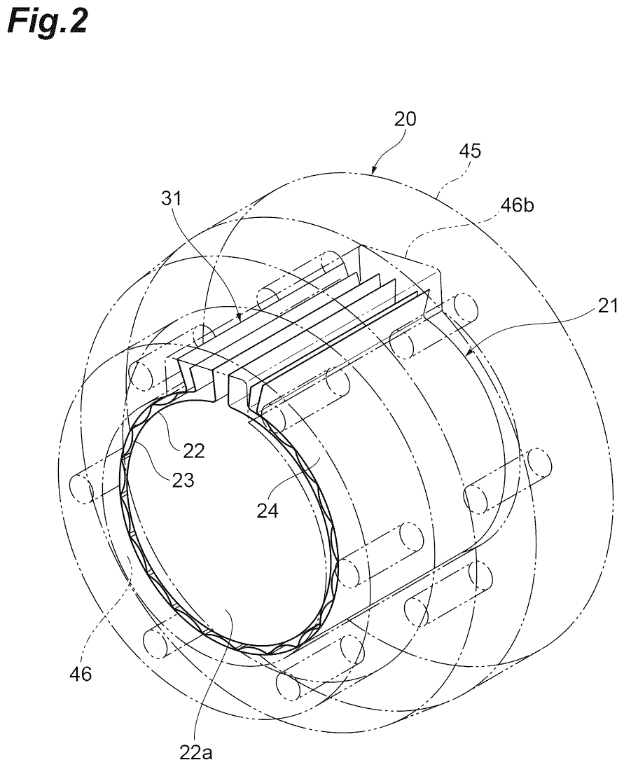

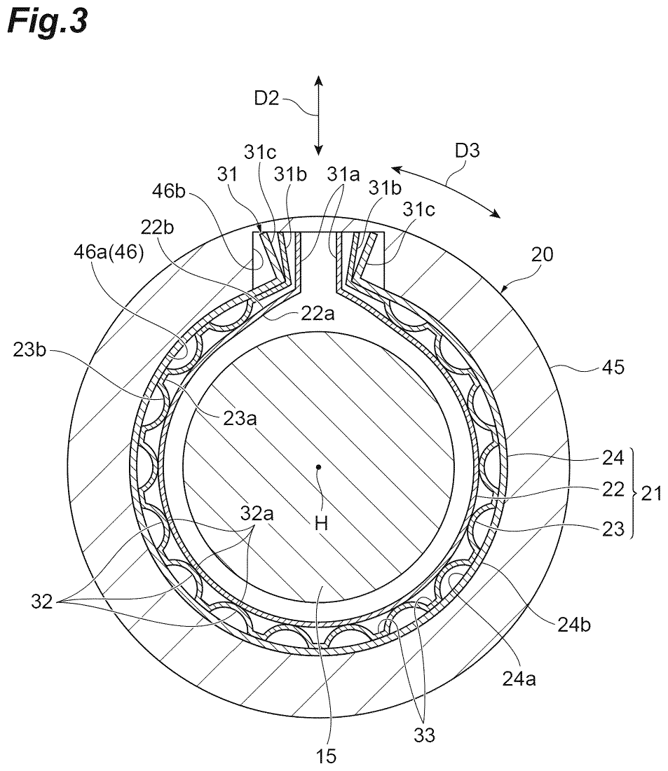

Subsequently, an example radial foil bearing 20 will be described in detail with reference to FIGS. 2 and 3. Note that the rotary machine 1 of the present disclosure includes the pair of radial foil bearings 20, and the pair of radial foil bearings 20 has substantially the same structure. Therefore, one radial foil bearing 20 will be described below as a representative.

The radial foil bearing 20 includes a foil assembly 21 and a bearing housing 45 housing the foil assembly 21. The foil assembly 21 includes a top foil 22, a bump foil 23 surrounding the top foil 22, and a set foil 24 surrounding the bump foil 23. As the rotating shaft 15 rotates, an air film is formed between the rotating shaft 15 and the top foil 22. The radial foil bearing 20 rotatably supports the rotating shaft 15 by forming the air film.

### <Bearing Housing>

The bearing housing 45 is a substantially cylindrical casing, and has a shaft hole 46 through which the rotating shaft 15 is inserted. The foil assembly 21 is accommodated in the shaft hole 46 so as to surround the rotating shaft 15. The bearing housing 45 is disposed to surround the bump foil 23 with the set foil 24 interposed therebetween. For example, the bearing housing 45 includes a cylindrical inner peripheral surface inside. This inner peripheral surface can be considered as an outer peripheral surface of the shaft hole 46. The inner peripheral surface faces the foil assembly 21 and substantially supports the foil assembly 21.

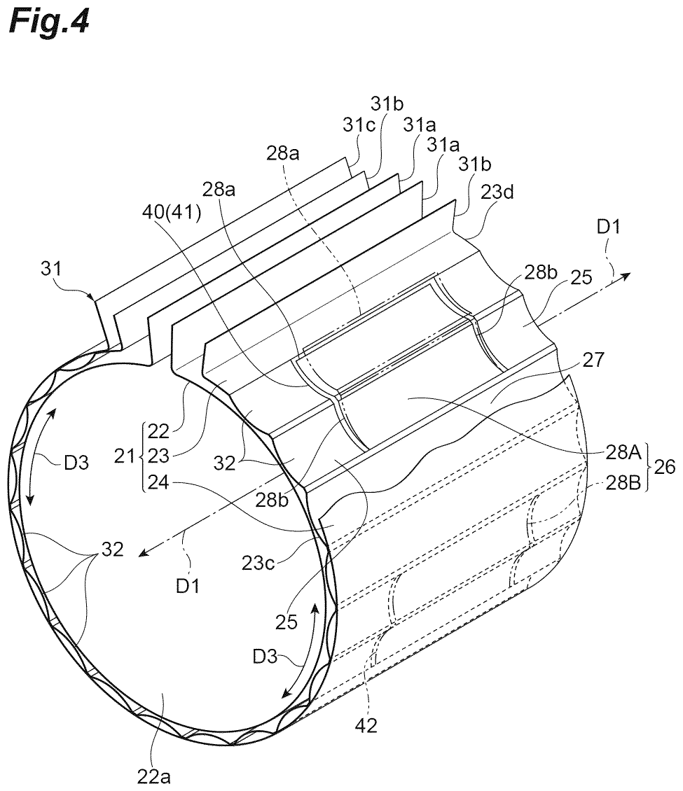

The shaft hole 46 penetrates the bearing housing 45 in the direction in which the rotation axis H extends. In the following description, a direction in which the shaft hole 46 extends, that is, a direction in which the rotation axis H (rotating shaft 15) extends is referred to as an “axial direction D1” (see FIG. 4). In addition, a radial direction of the shaft hole 46, that is, a direction perpendicular to the rotation axis H (rotating shaft 15) is referred to as a “radial direction D2”. Further, a circumferential direction of the rotating shaft 15, that is, a direction along a ring centered on the rotation axis H is referred to as a “circumferential direction D3”.

The bearing housing 45 is, for example, a member having sufficient strength to support the rotating shaft 15 that has stopped rotating. The rotating shaft 15 is disposed so as to pass through the center of the shaft hole 46 of the bearing housing 45. The foil assembly 21 rolled in a cylindrical shape is disposed between the inner peripheral surface 46a of the shaft hole 46 and the rotating shaft 15. The foil assembly 21 is provided with a locking structure 31 protruding in the radial direction D2, and the inner peripheral surface 46a of the shaft hole 46 is provided with a locking groove 46b in which the locking structure 31 is accommodated. The locking structure 31 is provided to extend in the axial direction D1, and the locking groove 46b is a vertically long groove extending in the axial direction D1 so as to accommodate the locking structure 31. The width of the locking groove 46b in the circumferential direction D3 corresponds to the width of the locking structure 31 in the circumferential direction D3, and the locking groove 46b can abut on the locking structure 31 in the circumferential direction D3. When the foil assembly 21 attempts to move in the circumferential direction D3 of the rotating shaft 15, the locking structure 31 interferes with the locking groove 46b. As a result, the rotation of the foil assembly 21 is suppressed.

### <Foil Assembly>

As illustrated in FIGS. 2, 3, and 4, the foil assembly 21 includes the top foil 22, the bump foil 23, and the set foil 24. Each of the top foil 22, the bump foil 23, and the set foil 24 is formed of a metal thin plate and has flexibility. The top foil 22, the bump foil 23, and the set foil 24 overlap in this order and have a cylindrical shape so that the top foil 22 is on the inner peripheral side.

### <Top Foil>

The cylindrical top foil 22 includes an inner peripheral surface facing the rotating shaft 15 and an outer peripheral surface 22b opposite to the inner peripheral surface. The inner peripheral surface is a facing surface 22a facing the rotating shaft 15. The top foil 22 in the unfolded state is a substantially rectangular thin plate without a slit or the like, and both ends in the longitudinal direction are first hooks 31a bent in an L shape.

### <Bump Foil>

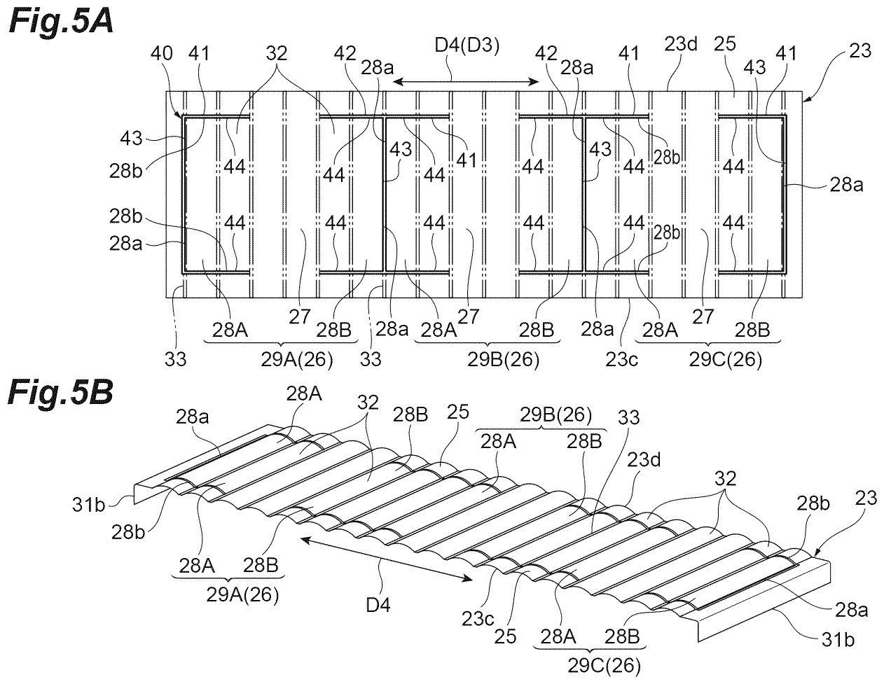

The cylindrical bump foil 23 includes an inner peripheral surface 23a facing the top foil 22 and an outer peripheral surface 23b opposite to the inner peripheral surface 23a. The bump foil 23 in the unfolded state (see FIGS. 5A, 5B) is a thin plate having a substantially rectangular shape in plan view, and both ends in a longitudinal direction D4 are second hooks 31b bent in an L shape. Note that the longitudinal direction D4 means the circumferential direction D3 in a state where the bump foil 23 is rolled. Therefore, in the following description, the longitudinal direction D4 and the circumferential direction D3 will be described as the circumferential direction D3 in a unified manner unless it may distinguish the longitudinal direction D4 and the circumferential direction D3.

Unlike the top foil 22, the bump foil 23 includes a plurality of curved portions (e.g., crest portions 32) provided side by side in the circumferential direction D3. The crest portions 32 are each intended to be a shape portion protruding so as to bulge inward with respect to the inner peripheral surface 23a, and a valley portion 33 is formed between the plurality of crest portions 32 on the inner peripheral surface 23a. Note that, with reference to the outer peripheral surface 23b, the crest portions 32 are recessed portions, and conversely, the valley portions 33 are bulged portions. Note that the crest portions 32 of the present disclosure have a corrugated shape in which concavo-convex shapes curved in the circumferential direction D3 are alternately formed, but the concavo-convex shapes may be discontinuous in the middle to partially form the crest portion. In addition, instead of the corrugated shape, a dome shape or a convex curved surface shape that forms a part of a sphere may be used.

The crest portions 32 are each curved in an arc shape in a cross-sectional view, can be expanded in the circumferential direction D3 by elastic expansion, and have flexibility, for example. This cross-sectional view is assumed to be a cross-sectional view when the bump foil 23 is cut along a plane along the circumferential direction D3. The crest portions 32 are provided to bulge inward facing the top foil 22. When the foil assembly 21 is formed, apexes 32a of the arc-shaped crest portions 32 can abut on the outer peripheral surface 22b of the top foil 22. In the bump foil 23 illustrated FIGS. 5A and 5B the plurality of crest portions 32 is arranged in the circumferential direction D3, and the apex 32a of each crest portion 32 extends in the axial direction D1. Thus, when a load in the radial direction D2 is applied to the bump foil 23, the bump foil 23 is expanded so as to extend (spread) in the circumferential direction D3 from the vicinity of the portion to which the load is applied.

The bump foil 23 includes a cylindrical portion 25, an elastic portion 26, and a coupling portion 27 that couples the cylindrical portion 25 and the elastic portion 26. The cylindrical portion 25 is a portion that surrounds the top foil 22 in a cylindrical shape. The cylindrical portion 25 is, for example, a portion that is continuous without interruption from one end portion to the other end portion of the bump foil 23 in the circumferential direction D3. Note that the meaning of the cylindrical portion 25 being a portion that is continuous without interruption in the circumferential direction D3 is, for example, a portion that is not divided by a slit or the like extending in the axial direction D1 in the middle of the circumferential direction D3. In addition, since it is sufficient that the cylindrical portion 25 is not completely cut in the axial direction D1, displacement in the axial direction D1 is not excluded. For example, the cylindrical portion 25 may be curved in the axial direction D1 halfway in the circumferential direction D3 between one end and the other end of the bump foil 23, or may be a structure having one continuous curved shape in the circumferential direction D3.

The elastic portion 26 is provided integrally with the cylindrical portion 25. The elastic portion 26 is located between the bearing housing 45 and the top foil 22 in a radial direction of the rotating shaft 15. The elastic portion 26 elastically support the cylindrical portion 25 via the coupling portion 27. The elastic portion 26 deform in a radial direction of the rotating shaft 15 without deforming the cylindrical portion 25 in the radial direction. The elastic portion 26 includes a first elastic piece 28A and a second elastic piece 28B extending in the circumferential direction D3 from the coupling portion 27. The first elastic piece 28A and the second elastic piece 28B are arranged so as to be adjacent to the cylindrical portion 25 in the axial direction D1, and can be expanded independently of the cylindrical portion 25. Therefore, for example, when a load is applied only to the first elastic piece 28A and the second elastic piece 28B, the first elastic piece 28A and the second elastic piece 28B are greatly expanded in the circumferential direction D3, and the cylindrical portion 25 is hardly expanded. As a result, the first elastic piece 28A and the second elastic piece 28B expand in the circumferential direction D3 more than the cylindrical portion 25.

As described later, the first elastic piece 28A and the second elastic piece 28B are formed by a slit structure 40, and the first elastic piece 28A and the second elastic piece 28B can be expanded independently of the cylindrical portion 25 by the slit structure 40. The first elastic piece 28A and the second elastic piece 28B do not affect each other by the width of the slit structure 40, and can be expanded in the circumferential direction D3. The thickness of the metal plate constituting the bump foil 23 is uniform. Therefore, the first elastic piece 28A and the second elastic piece 28B have a structure that is more readily deformed than the cylindrical portion 25.

The first elastic piece 28A and the second elastic piece 28B are supported on a cylindrical inner peripheral surface of the bearing housing 45. Note that “supported by the bearing housing 45” includes both the case of being directly supported in contact with the bearing housing 45 and the case of being indirectly supported with an inclusion present between the bearing housing 45 and the bearing housing. In the present disclosure, the set foil 24 is provided as an inclusion, and the first elastic piece 28A and the second elastic piece 28B are indirectly supported by the bearing housing 45.

The first elastic piece 28A and the second elastic piece 28B are curved so as to have flexibility, and can be expanded in the circumferential direction D3 so as to be elastically deformable. The first elastic piece 28A includes a peak edge portion 28a formed on the opposite side in the circumferential direction D3 with respect to the coupling portion 27, and a side edge portion 28b extending from the peak edge portion 28a to the coupling portion 27. Further, the second elastic piece 28B includes a peak edge portion 28a formed on the side opposite to the coupling portion 27 in the circumferential direction D3, and a side edge portion 28b extending from the peak edge portion 28a to the coupling portion 27. Here, “the side opposite to the coupling portion 27 in the circumferential direction D3” means a position of an end portion on the side opposite to the coupling portion 27 with respect to the circumferential direction D3.

It can also be described that the first elastic piece 28A extends from the coupling portion 27 in one direction with reference to the circumferential direction D3. It can also be described that the second elastic piece 28B extends from the coupling portion 27 in a direction opposite to one direction with reference to the circumferential direction D3. In addition, it can also be described that the peak edge portion 28a, which is a free end movable with the coupling portion 27 as a fulcrum, is formed at each tip of the first elastic piece 28A and the second elastic piece 28B.

When the bump foil 23 in the unfolded state (see FIG. 4) is rolled into a cylindrical shape, the first elastic piece 28A and the second elastic piece 28B are provided so as to protrude in a curved state toward the tangential direction of the cylindrical portion 25, for example. The bump foil 23 is surrounded by a set foil 24, and the set foil 24 is, for example, a thin plate having a substantially rectangular shape and having no slit or the like formed therein. While surrounded by the set foil 24, the first elastic piece 28A and the second elastic piece 28B are pressed against the set foil 24. As a result, a state in which the first elastic piece 28A and the second elastic piece 28B protrude so as to spring from the cylindrical portion 25 is eliminated. The first elastic piece 28A and the second elastic piece 28B are curved in an arc shape by abutting on the set foil 24. In addition, the first elastic piece 28A and the second elastic piece 28B elastically support the cylindrical portion 25 by abutting on the set foil 24 in a state of being curved in an arc shape, and further elastically support the top foil 22 via the cylindrical portion 25.

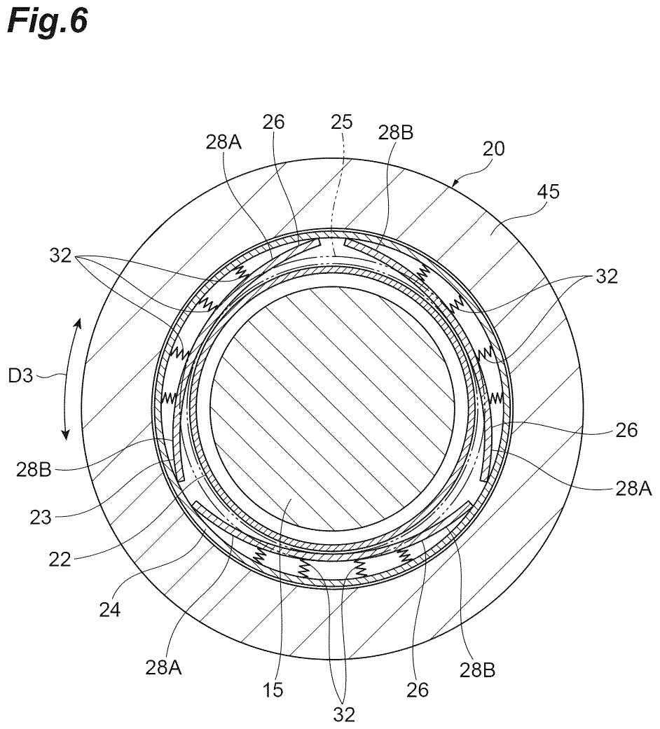

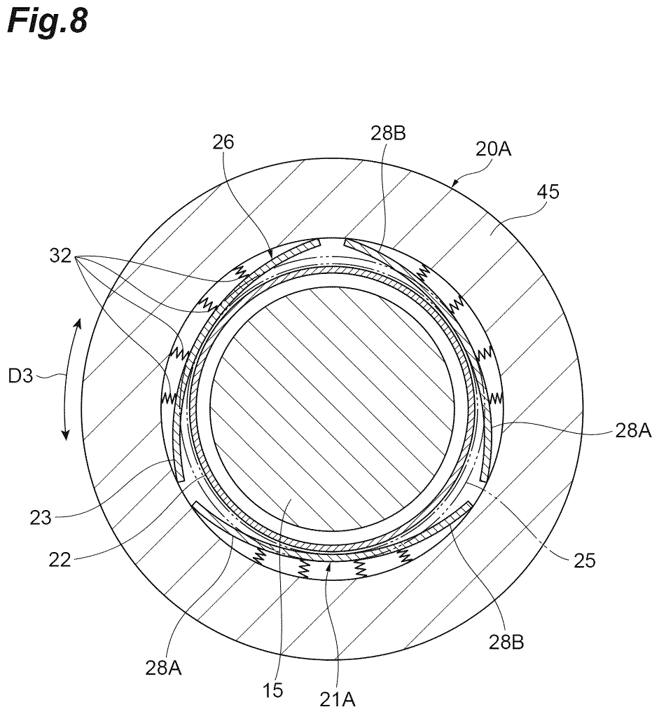

As described above, the elastic portion 26 includes the first elastic piece 28A and the second elastic piece 28B, and the first elastic piece 28A and the second elastic piece 28B are curved in an arc shape. In the present disclosure, the first elastic piece 28A and the second elastic piece 28B are provided with a plurality of crest portions 32. The crest portions 32 are already curved in an arc shape before the bump foil 23 is rolled. On the other hand, the “arc shape” of the first elastic piece 28A and the second elastic piece 28B is not formed in the state before the bump foil 23 is rolled up, and is a shape grasped separately from the arc shapes of the crest portions 32, and is formed by rolling the bump foil 23. For example, in a case where the first elastic piece 28A and the second elastic piece 28B are functionally grasped, for convenience, the plurality of crest portions 32 can be omitted and grasped as an arc shape without unevenness (see FIG. 6). The same applies to the cylindrical portion 25 in terms of function, and the plurality of crest portions 32 can be omitted and can be grasped as a cylindrical shape without unevenness. Note that, in FIG. 6, the crest portions 32 are functionally simply expressed as elastic bodies, and are illustrated as, for example, a spring having a simple shape. Further, in FIG. 8, the crest portions 32 are illustrated as springs having a simple shape similarly to FIG. 6.

As a functional concept, the first elastic piece 28A in which the crest portion 32 is omitted can be assumed as a curved plate-like portion extending in the circumferential direction D3 from the coupling portion 27. The curved plate-like portion can be grasped as a simple shape curved in an arc shape without waving. The same applies to the second elastic piece 28B, and as a result of functionally omitting the crest portion 32, the second elastic piece 28B can be grasped as a simple shape curved in an arc shape without waving. Further, the arc curvature center of the first elastic piece 28A and the second elastic piece 28B is located inside the bump foil 23. Note that the inward position of the bump foil 23 is an inward position closer to the rotating shaft 15 than the bump foil 23. Further, the curvature radius of the first elastic piece 28A is larger than the curvature radius of the cylindrical portion 25, and the curvature radius of the second elastic piece 28B is larger than the curvature radius of the cylindrical portion 25. Note that the crest portions 32 formed in the first elastic piece 28A and the second elastic piece 28B have an arc shape in which the center of curvature is located at a position outside the bump foil 23, and have a technical significance different from that of the arc shapes of the first elastic piece 28A and the second elastic piece 28B. Here, the outward position of the bump foil 23 is an outward position farther from the rotating shaft 15 than the bump foil 23.

Next, the slit structure 40 provided in the bump foil 23 will be described. First, the bump foil 23 includes a first circumferential edge 23c that is an end on one side in the axial direction D1, and a second circumferential edge 23d opposite to the first circumferential edge 23c in the axial direction D1. The slit structure 40 may form the first elastic piece 28A or the second elastic piece 28B independently of the first circumferential edge 23c and the second circumferential edge 23d, or may form the first elastic piece 28A or the second elastic piece 28B in cooperation with the first circumferential edge 23c or the second circumferential edge 23d.

Further, the slit structure 40 has a function as a boundary for separating the first elastic piece 28A and the second elastic piece 28B from the cylindrical portion 25, and forms a portion where the first elastic piece 28A and the second elastic piece 28B are connected to the coupling portion 27. The slit structure 40 includes a first slit continuous portion 41 forming the first elastic piece 28A and a second slit continuous portion 42 forming the second elastic piece 28B.

The first slit continuous portion 41 (see FIGS. 5A, 5B) includes a peak slit (e.g., slit 43) that forms a peak edge portion 28a and two (a plurality of) side slits 44 that are connected to communicate with the slit 43 and form a side edge portion 28b. The slit 43 extends, for example, in the axial direction D1. The slit 43 separates the distal end of the first elastic piece 28A from the cylindrical portion 25 so as to form the peak edge portion 28a. The side slit 44 extends in a direction intersecting the slit 43. The direction intersecting the slit 43 includes not only a direction orthogonal to the longitudinal direction of the slit 43 but also a direction inclined with respect to the direction orthogonal to the slit 43. The side slit 44 is provided so as to be connected to both ends of the slit 43. The side slit 44 extends in the circumferential direction D3 so as to separate the side edge portion 28b of the first elastic piece 28A from the cylindrical portion 25.

The slit 43 and the side slit 44 of the present disclosure are spaced apart from the first circumferential edge 23c and the second circumferential edge 23d, which are both side edges of the bump foil 23, and do not reach the first circumferential edge 23c or the second circumferential edge 23d. The slit 43 and the side slit 44 are provided to be closed in the bump foil 23 without being opened at the first circumferential edge 23c or the second circumferential edge 23d.

Further, the slit 43 is provided between the adjacent crest portions 32 so as to avoid the crest portions 32. Furthermore, the slit 43 is provided at the position of the valley portion 33 so as to extend along the crest portion 32. The peak edge portion 28a serving as a free end of the first elastic piece 28A and the second elastic piece 28B is provided along the valley portion 33. By providing the peak edge portion 28a while avoiding the crest portions 32, the elastic function of the crest portions 32 may be prevented from being hindered.

The second slit continuous portion 42 has substantially the same structure as the first slit continuous portion 41, and includes a slit 43 and two (a plurality of) side slits 44. The second slit continuous portion 42 is provided so as to be symmetric with respect to the first slit continuous portion 41 in the circumferential direction D3 of the rotating shaft 15.

The coupling portion 27 is disposed between the first slit continuous portion 41 and the second slit continuous portion 42. The coupling portion 27 is a portion that couples and integrates the first elastic piece 28A and the second elastic piece 28B with the cylindrical portion 25. The distance from the coupling portion 27 to the slit 43 of the first slit continuous portion 41 is the same as the distance from the coupling portion 27 to the slit 43 of the second slit continuous portion 42. Note that the distance from the coupling portion 27 to the slit 43 of the first slit continuous portion 41 may be different from the distance from the coupling portion 27 to the slit 43 of the second slit continuous portion 42.

In the present disclosure, the bump foil 23 is formed with a plurality of first slit continuous portions 41 and second slit continuous portions 42. As a result, the plurality of first elastic pieces 28A and the plurality of second elastic pieces 28B are formed. In addition, the plurality of elastic portions 26 is formed by forming the plurality of first elastic pieces 28A and the plurality of second elastic pieces 28B.

As illustrated in FIGS. 5A and 5B, for example, in the bump foil 23 in the unfolded state, the first slit continuous portion 41 and the second slit continuous portion 42 are alternately formed along the circumferential direction D3. As a result, the bump foil 23 in the unfolded state is formed so that the first elastic pieces 28A and the second elastic pieces 28B are alternately arranged along the circumferential direction D3. A single elastic portion 26 is formed by a combination (elastic piece unit) of the first elastic piece 28A and the second elastic piece 28B adjacent in the circumferential direction D3. The bump foil 23 of the present disclosure includes, for example, a first elastic piece unit 29A, a second elastic piece unit 29B, and a third elastic piece unit 29C along the circumferential direction D3. When the bump foil 23 is rolled, three (a plurality of) elastic portions 26 arranged in the circumferential direction D3 are formed by the first elastic piece unit 29A, the second elastic piece unit 29B, and the third elastic piece unit 29C (see FIG. 6).

The peak edge portion 28a of the first elastic piece unit 29A and the peak edge portion 28a of the second elastic piece unit 29B are formed by a slit 43 in common. The slit 43 forming the second elastic piece 28B of the first elastic piece unit 29A and the slit 43 forming the first elastic piece 28A of the second elastic piece unit 29B are made in common. Further, the slit 43 forming the second elastic piece 28B of the second elastic piece unit 29B and the slit 43 forming the first elastic piece 28A of the third elastic piece unit 29C are made in common. The peak edge portion 28a of one of the adjacent elastic portions 26 and the peak edge portion 28a of the other elastic portion 26 are formed by the slit 43 in common. By making the peak edge portion 28a of one of the adjacent elastic portions 26 and the peak edge portion 28a of the other elastic portion 26 in common by the single slit 43, the interval between the adjacent elastic portions 26 can be reduced. As a result, the shape and dimensions of the elastic portion 26, the number of the elastic portions formed in the circumferential direction D3, and the like can be easily optimized.

### <Set Foil>

As illustrated in FIGS. 3 and 4, the cylindrical set foil 24 is disposed to surround the bump foil 23 and supports the elastic portion 26, that is, the first elastic piece 28A and the second elastic piece 28B. When the elastic portion 26 is supported by the set foil 24, the first elastic piece 28A and the second elastic piece 28B may be supported in a state where elasticity is imparted, or may be supported in a state where elasticity does not occur. The set foil 24 includes an inner peripheral surface 24a facing the bump foil 23 and an outer peripheral surface 24b opposite the inner peripheral surface 24a. The set foil 24 in the unfolded state is a substantially rectangular thin plate, and both ends in the circumferential direction D3 are third hooks 31c bent in an L shape.

As illustrated in FIGS. 2 and 3, the top foil 22, the bump foil 23, and the set foil 24 are stacked in order from the inner peripheral side facing the rotating shaft 15. The first hooks 31a formed at both ends of the top foil 22, the second hooks 31b formed at both ends of the bump foil 23, and the third hooks 31c formed at both ends of the set foil 24 are arranged so as to overlap each other and form the locking structures 31. The locking structures 31 are accommodated in the locking groove 46b of the bearing housing 45.

FIG. 8 illustrates an example radial foil bearing. FIG. 8 is a schematic cross-sectional view for functionally describing a radial foil bearing 20A. Note that a radial foil bearing 20A illustrated in FIG. 8 has substantially the same structure and member as those of the radial foil bearing 20 illustrated in FIGS. 3 and 6. Therefore, the same structures and members are denoted by the same reference numerals, and a detailed description thereof will be omitted. The radial foil bearing 20A includes a foil assembly 21A and the bearing housing 45 that houses the foil assembly 21A. The foil assembly 21A does not include the set foil 24, and is formed by the top foil 22 and the bump foil 23. The elastic portion 26 of the bump foil 23 directly contacts the bearing housing 45 to elastically support the cylindrical portion 25, and further elastically supports the top foil 22 via the cylindrical portion 25. In addition, the elastic portion 26 bends while being in direct sliding contact with the bearing housing 45.

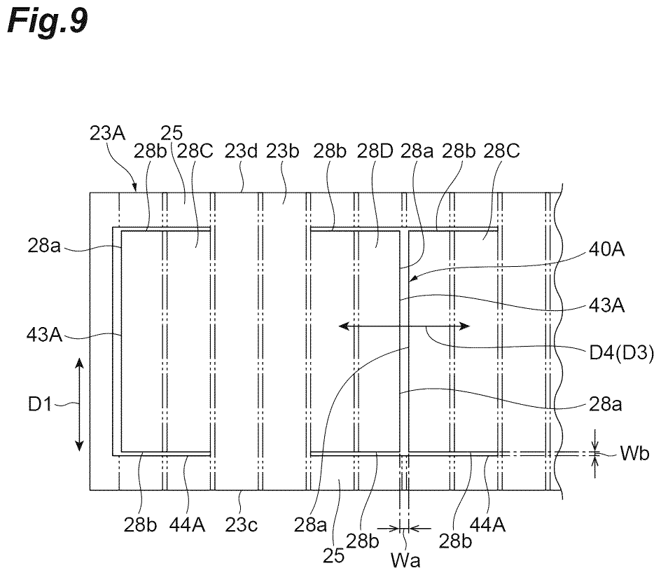

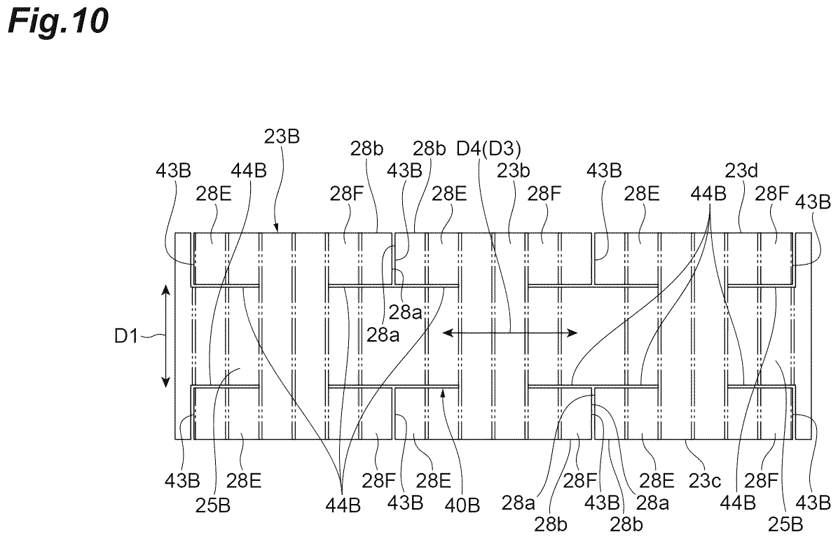

FIG. 9 illustrates an example bump foil. FIG. 9 is an enlarged plan view illustrating an example bump foil 23A and illustrating a part of an outer peripheral surface 23b of the bump foil 23A in an unfolded state. FIG. 10 is a plan view illustrating an example bump foil 23B and illustrating an outer peripheral surface 23b of the bump foil 23B in an unfolded state. Note that the bump foil 23A and the bump foil 23B may be applied to the radial foil bearings 20 and 20A described above, respectively.

The bump foil 23A includes a slit structure 40A that independently and deformably separates a first elastic piece 28C and a second elastic piece 28D from the cylindrical portion 25. In the first elastic piece 28C and the second elastic piece 28D adjacent in the circumferential direction D3, the peak edge portion 28a of the first elastic piece 28C and the peak edge portion 28a of the second elastic piece 28D are formed by a peak slit (e.g., slit 43A) in common. A width Wa of the slit 43A is larger than a width Wb of a side slit 44A. The width Wa of the slit 43A means the width of the bump foil 23 in the circumferential direction D3, and means the width of the bump foil 23 in the rolled state in the circumferential direction D3. Further, the width Wb of the side slit 44A means a width in the axial direction D1.

The peak edge portion 28a of the first elastic piece 28C and the peak edge portion 28a of the second elastic piece 28D move in an approaching direction when the first elastic piece 28C and the second elastic piece 28D are flexed and expanded. Here, since the width Wa of the slit 43A forming the peak edge portion 28a is larger than the width Wb of the side slit 44A, interference between the peak edge portions 28a can be easily prevented as compared with a case where the width of the slit 43 and the width of the side slit 44 are the same.

As illustrated in FIG. 10, the bump foil 23B includes a first circumferential edge 23c that is an end on one side in the axial direction D1, and a second circumferential edge 23d opposite to the first circumferential edge 23c in the axial direction D1. A cylindrical portion 25B of the bump foil 23B is provided at a position spaced apart from the first circumferential edge 23c and the second circumferential edge 23d. For example, the cylindrical portion 25B includes a central region between the first circumferential edge 23c and the second circumferential edge 23d, and is provided to extend in the circumferential direction D3 (circumferential direction D3). The bump foil 23B includes a first elastic piece 28E and a second elastic piece 28F adjacent to the cylindrical portion 25B in the axial direction D1. The first elastic piece 28E and the second elastic piece 28F are provided between the first circumferential edge 23c or the second circumferential edge 23d and the cylindrical portion 25B. For example, among the multiple first elastic pieces 28E, some of the first elastic pieces 28E are located between the first circumferential edge 23c and the cylindrical portion 25, while other first elastic pieces 28E are located between the second circumferential edge 23d and the cylindrical portion 25. Among the multiple first elastic pieces 28F, some of the first elastic pieces 28F are located between the first circumferential edge 23c and the cylindrical portion 25, while other first elastic pieces 28E are located between the second circumferential edge 23d and the cylindrical portion 25.

The bump foil 23B includes a slit structure 40B that independently and deformably separates the first elastic piece 28E and the second elastic piece 28F from the cylindrical portion 25B. The slit structure 40B includes a peak slit (e.g., slit 43B) that forms the peak edge portion 28a and a side slit 44B that is connected to the slit 43B and forms the side edge portion 28b. The slit 43B is opened at the first circumferential edge 23c or the second circumferential edge 23d.

At least a part of the side edge portion 28b of the first elastic piece 28E and the second elastic piece 28F is formed at the first circumferential edge 23c or the second circumferential edge 23d. Out of the pair (plurality) of side edge portions 28b forming the first elastic piece 28E, a part of the side edge portions 28b is formed at the first circumferential edge 23c or the second circumferential edge 23d, and the other side edge portion 28b is formed by the side slit 44B. Further, out of the pair (plurality) of side edge portions 28b forming the second elastic piece 28F, a part of the side edge portions 28b is formed at the first circumferential edge 23c or the second circumferential edge 23d, and the other side edge portion 28b is formed by the side slit 44B. In the case of the bump foil 23B, the slit structure 40B forms the first elastic piece 28E or the second elastic piece 28F in cooperation with the first circumferential edge 23c or the second circumferential edge 23d.

### <Method for Manufacturing Radial Foil Bearing>

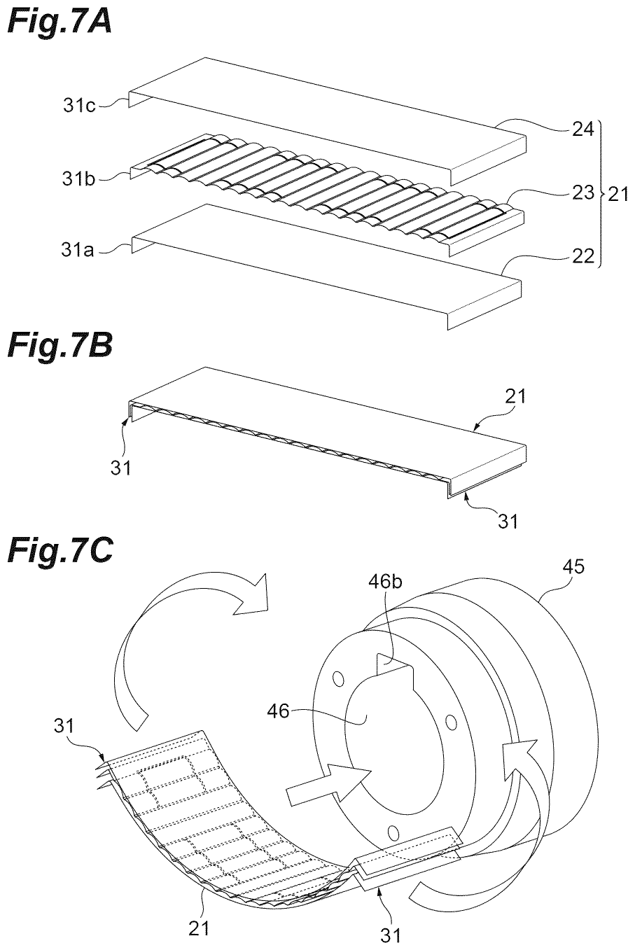

Next, a method for manufacturing the radial foil bearing 20 will be described with reference to FIGS. 7A, 7B and 7C. The manufacturing method of the present disclosure includes a foil forming operation, a foil assembly forming operation, and a foil assembly installing operation.

The foil forming operation includes a top foil forming operation, a bump foil forming operation, and a set foil forming operation. In the top foil forming operation, a metal first plate-like member is processed into a predetermined shape (for example, rectangular) to form the top foil 22 in the unfolded state. Further, both ends of the top foil 22 in the circumferential direction D3 are bent to form the first hooks 31a. Note that, in an example method for manufacturing the radial foil bearing 20A, the set foil forming operation can be omitted. Further, in the case of using the top foil 22, the bump foils 23, 23A, and 23B, and the set foil 24 processed into a desired shape, the foil forming operation can be omitted.

In the bump foil forming operation, a metal second plate-like member is processed into a predetermined shape (for example, rectangular) to form the bump foil 23 in the unfolded state. Both ends of the bump foil 23 in the circumferential direction D3 are bent to form the second hooks 31b. Further, the slit structure 40 for forming the cylindrical portion 25 and the elastic portion 26 is formed in the bump foil 23. The elastic portion 26 includes the first elastic pieces 28A, 28C, and 28E and the second elastic pieces 28B, 28D, and 28F. Further, the bump foil 23 is processed to form the plurality of arc-shaped crest portions 32. By forming the slit structure 40, the cylindrical portion 25 and the elastic portion 26 may be integrally formed when the bump foil 23 is rolled. It may form the elastic portion 26 without combining a plurality of members. The slit structure 40 may be formed before the formation of the crest portions 32 or after the formation of the crest portions 32.

In the set foil forming operation, a metal third plate-like member is processed into a predetermined shape (for example, rectangular) to form the set foil 24 in the unfolded state. Both ends of the set foil 24 in the circumferential direction D3 are bent to form the third hooks 31c.

As illustrated in FIG. 7B and FIG. 7C, in the foil assembly forming operation, a stacked body in which the top foil 22 in the unfolded state, the bump foil 23 in the unfolded state, and the top foil 22 in the unfolded state are overlapped is rolled to form a cylindrical foil assembly 21. In forming the foil assembly 21, the first hooks 31a, the second hooks 31b, and the third hooks 31c are overlapped to form the locking structures 31. When the bump foil 23 is rolled to form the foil assembly 21, the slit structure 40 forms an elastic portion 26.

In the foil assembly installing operation, the foil assembly 21 is inserted into the bearing housing 45 so as to surround the rotating shaft 15 to form the radial foil bearing 20. The foil assembly 21 is inserted into the shaft hole 46 of the bearing housing 45. A ring-shaped pressing member or the like is installed at an end portion of the bearing housing 45 in the axial direction D1 (see FIG. 1) to regulate displacement of the foil assembly 21 in the axial direction D1.

Next, operational effects exhibited by the radial foil bearings 20 and 20A of the present disclosure will be described.

The bump foils 23, 23A, and 23B of the radial foil bearings 20 and 20A include the cylindrical portion 25 and the elastic pieces 28A to 28F. The elastic pieces 28A to 28F are deformable independently of the cylindrical portion 25. The elastic pieces 28A to 28F are directly or indirectly supported by the bearing housing 45, and support the top foil 22 via the cylindrical portion 25 adjacent in the axial direction D1. Further, the elastic pieces 28A to 28F can be expanded in the circumferential direction D3 while being directly or indirectly supported by the bearing housing 45.

The elastic pieces 28A to 28F of the radial foil bearing 20 deflect while being in indirect sliding contact with the bearing housing 45, and the elastic pieces 28A to 28F of the radial foil bearing 20A deflect while being in direct sliding contact with the bearing housing 45. When elastically deformed and expanded while being indirectly or directly supported by the bearing housing 45, the elastic pieces 28A to 28F elastically support the cylindrical portion 25, and further elastically support the top foil 22 via the cylindrical portion 25. As a result, the radial foil bearings 20 and 20A are also resistant to vibration of the rotating shaft 15 rotating at a high speed, and the like, and the rotating shaft 15 can be stably supported.

Further, in the present disclosure, since the elastic pieces 28A to 28F and the cylindrical portion 25 are integrally formed, when installation of the cylindrical portion 25 is completed, installation of the elastic pieces 28A to 28F is completed. As a result, assemblability at the time of installing the bump foils 23, 23A, and 23B can be improved.

Further, the bump foils 23, 23A, and 23B include the coupling portion 27 that couples the elastic pieces 28A to 28F and the cylindrical portion 25. Each of the elastic pieces 28A to 28F includes the peak edge portion 28a formed on the opposite side in the circumferential direction D3 with respect to the coupling portion 27, and the side edge portion 28b extending from the peak edge portion 28a to the coupling portion 27. Since the peak edge portion 28a is formed by the slit structure 40, 40A, or 40B to be a free end, the peak edge portion can be moved with the coupling portion 27 as a fulcrum.

The elastic pieces 28A to 28F elastically support the rotating shaft 15 via the top foil 22 by expansion thereof. Further, the elastic pieces 28A to 28F include the plurality of crest portions 32 arranged adjacent to each other in the circumferential direction D3. The plurality of crest portions 32 can be elastically deformed and expanded in the circumferential direction D3. Since the radial foil bearings 20 and 20A include the plurality of crest portions 32, the top foil 22 can be elastically supported by expansion of each of the plurality of crest portions 32 in addition to development of the elastic pieces 28A to 28F. Further, the slits 43, 43A, or 43B forming the peak edge portions 28a of the elastic pieces 28A to 28F are provided between the adjacent crest portions 32 so as to avoid the crest portions 32. As a result, the elastic function of the plurality of crest portions 32 expandable in the circumferential direction D3 is hardly impaired by the elastic deformation.

Further, the radial foil bearings 20 and 20A of the present disclosure also include the set foil 24 that supports the first elastic pieces 28A, 28C, 28E and the second elastic pieces 28B, 28D, 28F. The set foil 24 may prevent the first elastic pieces 28A, 28C, and 28E and the second elastic pieces 28B, 28D, and 28F from springing outward from the cylindrical portion 25 and prevent the elastic function from deteriorating. In addition, by providing the set foil 24, friction is generated between the bump foil 23 and the set foil 24, and damping performance is improved.

Further, in the first elastic pieces 28A, 28C, and 28E and the second elastic pieces 28B, 28D, and 28F adjacent to each other in the circumferential direction D3, the peak edge portions 28a of the first elastic pieces 28A, 28C, and 28E and the peak edge portions 28a of the second elastic pieces 28B, 28D, and 28F are formed by the slits 43, 43A, and 43B in common. By making the slits 43A or 43B in common, the interval between the adjacent first elastic pieces 28A, 28C, and 28E and the adjacent second elastic pieces 28B, 28D, and 28F can be reduced, and the shapes and dimensions of the first elastic pieces 28A, 28C, and 28E and the second elastic pieces 28B, 28D, and 28F and the number of the first elastic pieces 28A, 28C, and 28E and the second elastic pieces 28B, 28D, and 28F formed in the circumferential direction D3, and the like can be easily optimized.

In addition, in the bump foil 23A according to Modification 1, the width Wa of the slit 43A in the circumferential direction D3 is larger than the width Wb of the side slit 44A in the axial direction D1. For example, when the peak edge portion 28a of the first elastic piece 28C and the peak edge portion 28a of the second elastic piece 28D are formed by the slit 43A in common, when the first elastic piece 28C or the second elastic piece 28D is expanded, the peak edge portions 28a move in a direction of approaching each other. Here, since the width Wa of the slit 43A is larger than the width Wb of the side slit 44A, it may prevent interference between the peak edge portions 28a as compared with a case where the width of the slit and the width of the side slit are the same.

Further, in the bump foil 23 or 23A, the slits 43 or 43B and the side slits 44 or 44B of the slit structure 40 or 40A are spaced apart from the first circumferential edge 23c and the second circumferential edge 23d of the bump foils 23 and 23A. Further, the slits 43 or 43B and the side slits 44 or 44B are provided so as to be closed in the bump foil 23 or 23A. As a result, it may form the first elastic pieces 28A and 28C and the second elastic pieces 28B and 28D having a desired elastic force at a position spaced apart from the first circumferential edge 23c or the second circumferential edge 23d, for example, at a position close to the center in the axial direction D1.

Further, the slit structure 40B of the bump foil 23B according to the second modification includes the slit 43B forming the peak edge portion 28a, and the slit 43B is opened at the first circumferential edge 23c or the second circumferential edge 23d. As a result, the peak edge portion 28a can be easily formed by making a cut or the like from the first circumferential edge 23c or the second circumferential edge 23d.

Further, the plurality of crest portions 32 is also provided in the coupling portion 27 in addition to the elastic pieces 28A to 28F. The coupling portion 27 is less likely to bend as compared with the elastic pieces 28A to 28F. On the other hand, the elastic pieces 28A to 28F are more easily bent as the elastic pieces are farther from the coupling portion 27 in the circumferential direction D3 and closer to the peak edge portion 28a. The elastic supporting force of the crest portions 32 with respect to the top foil 22 decreases more at a position where the elastic pieces 28A to 28F are more easily bent. Therefore, this elastic supporting force is the largest at the coupling portion 27, and is smaller as it is closer to each peak edge portion 28a of the elastic pieces 28A to 28F. The elastic support force that supports the top foil 22 by the plurality of crest portions 32 is not uniform but varies in the circumferential direction D3. By arranging the plurality of crest portions 32 so that the elastic supporting force changes, stability of the top foil 22 that vibrates by interfering with the rotating shaft 15 can be improved, and the stability when supporting the rotating shaft 15 rotating at a high speed is improved.

Further, in the method for manufacturing the radial foil bearing 20, the top foil 22, the bump foils 23, 23A, and 23B, and the set foil 24 are rolled to form the foil assembly 21 in the foil assembly forming operation, and the foil assembly 21 is inserted and installed in the bearing housing 45 so as to surround the rotating shaft 15 in the foil assembly installing operation. This manufacturing method may improve assemblability when manufacturing the radial foil bearing 20. Further, the radial foil bearing 20 manufactured by this manufacturing method may stably support the rotating shaft 15 during high-speed rotation.

Note that, in the above manufacturing method, in addition to the top foil 22 in the unfolded state and the bump foil 23 in the unfolded state, the set foil 24 in the unfolded state is rolled in an overlapped state to form the foil assembly 21. However, in some examples the radial foil bearing 20A may be manufactured in which the set foil 24 is omitted. When the radial foil bearing 20A is manufactured, the foil assembly 21A is formed by overlapping and rolling the top foil 22 in the unfolded state and the expanded bump foil 23 in the unfolded state. In the foil assembly installing operation, the foil assembly 21A is inserted and installed in the bearing housing 45 so as to surround the rotating shaft 15.

The radial foil bearing according to the present disclosure is not limited to the above-described examples, and various other modifications are possible. For example, the elastic piece may have a configuration in which a plurality of crest portions is omitted. Additionally, the first elastic piece may be a single arc-shaped plate-like portion as a whole without including a plurality of arc-shaped crest portions. Further, the second elastic piece may be a single arc-shaped plate-like portion as a whole without including a plurality of arc-shaped crest portions.

Some additional examples are disclosed as follows, with continued reference to the drawings for convenience of description.

An example radial foil bearing (20, 20A) may include a top foil (22) configured to surround a rotating shaft (15), a bump foil (23) located outside of the top foil (22), and a bearing housing (45) surrounding the bump foil (23). The bump foil (23) may include a cylindrical portion (25) surrounding the top foil (22), and an elastic piece (28A) located between the bearing housing (45) and the top foil (22) in a radial direction of the rotating shaft, and located adjacent to the cylindrical portion (25) in an axial direction of the rotating shaft (15). the elastic piece (28A) may be configured to deform independently of the cylindrical portion (25).

In the radial foil bearing (20, 20A), the elastic piece (28A) may be configured to deform in a circumferential direction of the cylindrical portion (25) without deforming the cylindrical portion (25) in the circumferential direction.

The radial foil bearing (20, 20A) may include a coupling portion (27) coupling the cylindrical portion (25) and the elastic piece (28A). In the radial foil bearing (20, 20A), the elastic piece (28A) may be configured to elastically support the cylindrical portion (25) via the coupling portion (27).

In the radial foil bearing (20, 20A), the elastic piece (28A) may protrude from the coupling portion (27) in a tangential direction of the cylindrical portion (25).

In the radial foil bearing (20, 20A), the elastic piece (28A) may include a curved portion (32) configured to expand in a circumferential direction of the cylindrical portion (25).

In the radial foil bearing (20, 20A), the elastic piece (28A) and the cylindrical portion (25) may be integrally formed, and the bump foil (23) may include a slit structure (40) separating the elastic piece (28A) from the cylindrical portion (28A) so that the elastic piece (28A) is deformable independently of the cylindrical portion (25).

In the radial foil bearing (20, 20A), the bump foil (23) may include a coupling portion (27) coupling the cylindrical portion (25) and the elastic piece (28A). The elastic piece (28A) may include a peak edge portion (28A) located on a side opposite to the coupling portion (27) in a circumferential direction of the cylindrical portion (25), and a side edge portion (28b) extending from the peak edge portion (28A) to the coupling portion (27). The peak edge portion (28A) may be formed by the slit structure (40) and includes a free end.

In the radial foil bearing (20, 20A), the bump foil (23) may include a first circumferential edge (23c), and a second circumferential edge (23d) opposite to the first circumferential edge (23c) in the axial direction of the rotating shaft. The slit structure (40) may include a peak slit (43) forming the peak edge portion (28a), and a side slit (44) connected to the peak slit (43) and forming the side edge portion (28b). The peak slit (43) and the side slit (44) may be spaced apart from the first circumferential edge (23c) and the second circumferential edge (23d) and are enclosed within the bump foil (23).

In the radial foil bearing (20, 20A), one end of the bump foil (23) in the axial direction of the rotating shaft (15) may include a circumferential edge (23c). The slit structure (40) may include a peak slit (43) forming the peak edge portion (28a). The peak slit (43) may be opened at the circumferential edge (23c). At least a portion of the side edge portion (28b) may be formed at the circumferential edge (23c) where the peak slit (43) is opened.

In the radial foil bearing (20, 20A), the slit structure (40) may include a peak slit (43) forming the peak edge portion (28a). The elastic piece (28A) may include a plurality of curved portions (32) arranged adjacent to each other in the circumferential direction and expandable in the circumferential direction by elastic deformation. The peak slit (43) may extend along the curved portions (32) between the curved portions (32) arranged adjacent to each other.

In the radial foil bearing (20, 20A), the slit structure (40) may include a peak slit (43) forming the peak edge portion (28a). A plurality of the elastic pieces (28A,28B) may be provided side by side in the circumferential direction. The peak edge portion (28a) of one of the elastic pieces (28A, 28B) adjacent to each other and the peak edge portion (28a) of another of the elastic pieces (28A, 28B) are formed by the peak slit (43).

In the radial foil bearing (20, 20A), the slit structure (40) may include a side slit (44) forming the side edge portion (28b). A width (Wa) of the peak slit (43) in the circumferential direction may be larger than a width (Wb) of the side slit (44) in an axial direction of the rotating shaft (15).

The radial foil bearing (20, 20A) may include a set foil (24) disposed to surround the bump foil (23) and supporting the elastic piece (28A) in a state where elasticity is imparted to the elastic piece.

An example method for manufacturing a radial foil bearing (20, 20A), wherein the a radial foil bearing (20, 20A) includes a top foil (22), a bump foil (23) surrounding the top foil (22), and a bearing housing (45) supporting the bump foil (23), the method may include rolling a stack in which the top foil (22) in an unfolded state and the bump foil (23) in an unfolded state are overlapped to form a cylindrical foil assembly, and inserting and installing the foil assembly into a cylindrical bearing housing (45) so as to surround a rotating shaft (15). The bump foil (23) may include a cylindrical portion (25) surrounding the top foil (22), and an elastic piece (28A) located between the bearing housing (45) and the top foil (22) in a radial direction of the rotating shaft, and located adjacent to the cylindrical portion in an axial direction of the rotating shaft, the elastic piece portion being configured to deform independently of the cylindrical portion (25). The elastic piece (28A) may be supported by the bearing housing (45) as a result of inserting the foil assembly into the bearing housing.

In forming the foil assembly (21, 21A), a set foil (24) in an unfolded state may be disposed so as to overlap the bump foil (23) on a side opposite to the top foil (22) to form the stack, and the stack is rolled to form the foil assembly (21).

An example A radial foil bearing (20, 20A) may include a top foil (22) formed into a cylindrical shape, a bump foil (23) surrounding top foil (22), and a bearing housing (45) surrounding the bump foil (23). The bump foil (23) may include a cylindrical portion (25) contacting with the top foil (22), an elastic portion (26) supported by the bearing housing (45), and a coupling portion (27) coupling the cylindrical portion (25) and the elastic portion (26). The elastic portion (26) may be configured to elastically support the cylindrical portion (25) via the coupling portion (27).

In the radial foil bearing (20, 20A), the elastic portion (26) may be configured to deform in a radial direction of the rotating shaft (15) without deforming the cylindrical portion (25) in the radial direction.

In the radial foil bearing (20, 20A), wherein the elastic portion (26) may include a curved portion (32) configured to expand in a circumferential direction of the cylindrical portion (25).

In the radial foil bearing (20, 20A), the elastic portion (26) may include a first elastic piece (28A) which protrudes from the coupling portion (27) in a tangential direction of the cylindrical portion (25), and a second elastic piece (28B) which protrudes from the coupling portion (27) in the tangential direction of the cylindrical portion (25).

In the radial foil bearing (20, 20A), the top foil (22) may be configured to surround a rotating shaft (15). The bump foil (23) may include a first circumferential edge (23c), and a second circumferential edge (23d) located opposite to the first circumferential edge (23c) in an axial direction of the rotating shaft (15). The first elastic piece (28E, 28F) is located between the first circumferential edge (23c) and the cylindrical portion (25). The second elastic piece (28E,28F) is located between the second circumferential edge (23d) and the cylindrical portion (25).

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A radial foil bearing comprising:
a top foil configured to surround a rotating shaft;
a bump foil located outside of the top foil; and
a bearing housing surrounding the bump foil,
wherein the bump foil includes:
a cylindrical portion surrounding the top foil; and
an elastic piece located between the bearing housing and the top foil in a radial direction of the rotating shaft, and located adjacent to the cylindrical portion in an axial direction of the rotating shaft, and
wherein the elastic piece is configured to deform independently of the cylindrical portion.

2. The radial foil bearing according to claim 1, wherein the elastic piece is configured to deform in a circumferential direction of the cylindrical portion without deforming the cylindrical portion in the circumferential direction.

3. The radial foil bearing according to claim 1,
further comprising a coupling portion coupling the cylindrical portion and the elastic piece,
wherein the elastic piece is configured to elastically support the cylindrical portion via the coupling portion.

4. The radial foil bearing according to claim 3, wherein the elastic piece protrudes from the coupling portion in a tangential direction of the cylindrical portion.

5. The radial foil bearing according to claim 1, wherein the elastic piece includes a curved portion configured to expand in a circumferential direction of the cylindrical portion.

6. The radial foil bearing according to claim 1,
wherein the elastic piece and the cylindrical portion are integrally formed, and
wherein the bump foil includes a slit structure separating the elastic piece from the cylindrical portion so that the elastic piece is deformable independently of the cylindrical portion.

7. The radial foil bearing according to claim 6,
wherein the bump foil includes a coupling portion coupling the cylindrical portion and the elastic piece,
wherein the elastic piece includes:
a peak edge portion located on a side opposite to the coupling portion in a circumferential direction of the cylindrical portion; and
a side edge portion extending from the peak edge portion to the coupling portion, and
wherein the peak edge portion is formed by the slit structure and includes a free end.

8. The radial foil bearing according to claim 7,
wherein the bump foil includes:
a first circumferential edge; and
a second circumferential edge opposite to the first circumferential edge in the axial direction,
wherein the slit structure includes:
a peak slit forming the peak edge portion; and
a side slit connected to the peak slit and forming the side edge portion, and
wherein the peak slit and the side slit are spaced apart from the first circumferential edge and the second circumferential edge and are enclosed within the bump foil.

9. The radial foil bearing according to claim 7,
wherein one end of the bump foil in the axial direction of the rotating shaft includes a circumferential edge,
wherein the slit structure includes a peak slit forming the peak edge portion,
wherein the peak slit is opened at the circumferential edge, and
wherein at least a portion of the side edge portion is formed at the circumferential edge where the peak slit is opened.

10. The radial foil bearing according to claim 7,
wherein the slit structure includes a peak slit forming the peak edge portion,
wherein the elastic piece includes a plurality of curved portions arranged adjacent to each other in the circumferential direction and expandable in the circumferential direction by elastic deformation, and
wherein the peak slit extends along the curved portions between the curved portions arranged adjacent to each other.

11. The radial foil bearing according to claim 7,
wherein the slit structure includes a peak slit forming the peak edge portion,
wherein a plurality of the elastic pieces are provided side by side in the circumferential direction, and
wherein the peak edge portion of one of the elastic pieces adjacent to each other and the peak edge portion of another of the elastic pieces are formed by the peak slit.

12. The radial foil bearing according to claim 11,
wherein the slit structure further includes a side slit forming the side edge portion, and
wherein a width of the peak slit in the circumferential direction is larger than a width of the side slit in the axial direction of the rotating shaft.

13. The radial foil bearing according to claim 1, further comprising a set foil disposed to surround the bump foil and supporting the elastic piece in a state where elasticity is imparted to the elastic piece.

14. A method for manufacturing a radial foil bearing comprising a top foil, a bump foil surrounding the top foil, and a bearing housing supporting the bump foil, the method comprising:
rolling a stack in which the top foil in an unfolded state and the bump foil in an unfolded state are overlapped to form a cylindrical foil assembly; and
inserting and installing the foil assembly into a cylindrical bearing housing so as to surround a rotating shaft,
wherein the bump foil includes a cylindrical portion surrounding the top foil, and an elastic piece located between the bearing housing and the top foil in a radial direction of the rotating shaft, and located adjacent to the cylindrical portion in an axial direction of the rotating shaft, the elastic piece being configured to deform independently of the cylindrical portion, and
wherein the elastic piece is supported by the bearing housing as a result of inserting the foil assembly into the bearing housing.

15. The method for manufacturing the radial foil bearing according to claim 14, wherein in forming the foil assembly, a set foil in an unfolded state is disposed so as to overlap the bump foil on a side opposite to the top foil to form the stack, and the stack is rolled to form the foil assembly.

16. A radial foil bearing comprising:
a top foil formed into a cylindrical shape;
a bump foil surrounding top foil; and
a bearing housing surrounding the bump foil,
wherein the bump foil includes:
a cylindrical portion contacting with the top foil;
an elastic portion supported by the bearing housing; and
a coupling portion coupling the cylindrical portion and the elastic portion, and
wherein the elastic portion is configured to elastically support the cylindrical portion via the coupling portion.

17. The radial foil bearing according to claim 16, wherein the elastic portion is configured to deform in a radial direction of the rotating shaft without deforming the cylindrical portion in the radial direction.

18. The radial foil bearing according to claim 16, wherein the elastic portion comprises a curved portion configured to expand in a circumferential direction of the cylindrical portion.

19. The radial foil bearing according to claim 16, wherein the elastic portion comprises:
a first elastic piece which protrudes from the coupling portion in a tangential direction of the cylindrical portion; and
a second elastic piece which protrudes from the coupling portion in the tangential direction of the cylindrical portion.

20. The radial foil bearing according to claim 19,
wherein the top foil is configured to surround a rotating shaft,
wherein the bump foil comprises:
a first circumferential edge; and
a second circumferential edge located opposite to the first circumferential edge in an axial direction of the rotating shaft,
wherein the first elastic piece is located between the first circumferential edge and the cylindrical portion, and
wherein the second elastic piece is located between the second circumferential edge and the cylindrical portion.
